(19) United States
(12) Patent Application Publication
(10) Pub. No.: US 2023/0410348 A1
(43) Pub. Date: Dec. 21, 2023

(54) Object Detection Outside a User Field-of-View

(71) Applicant: Apple Inc., Cupertino, CA (US)

(72) Inventors: Brett D. Miller, San Carlos, CA (US); Daniel K. Boothe, San Francisco, CA (US); Martin E. Johnson, Los Gatos, CA (US)

(21) Appl. No.: 18/211,513

(22) Filed: Jun. 19, 2023

Related U.S. Application Data
(60) Provisional application No. 63/354,014, filed on Jun. 21, 2022.

(51) Int. Cl. G06T 7/70; G06T 7/20; G06F 3/01; G06F 3/16; H04S 7/00; H04R 5/033

(52) U.S. Cl. CPC G06T 7/70; G06T 7/20; G06F 3/013; G06F 3/167; H04S 7/304; H04R 5/033; H04S 2400/11

(57) ABSTRACT

In one implementation, a method of playing an audio notification is performed at a device including one or more image sensors, one or more speakers, one or more processors, and non-transitory memory. The method includes receiving, from the one or more image sensors, an image of a physical environment having a device field-of-view different than a user field-of-view. The method includes detecting, in the image of the physical environment, an object at a location in the physical environment. The method includes determining that the location in the physical environment is outside an area of the user field-of-view. The method includes, in response to determining that the location in the physical environment is outside the area of the user field-of-view, playing, via the speaker, an audio notification of the detection.

### CROSS-REFERENCE TO RELATED APPLICATIONS

This application claims priority to U.S. Provisional Patent No. 63/354,014, filed on Jun. 21, 2022, which is hereby incorporated by reference in its entirety.

### TECHNICAL FIELD

The present disclosure generally relates to detecting an object outside a field-of-view of a user.

### BACKGROUND

In various implementations, an electronic device detects objects in a physical environment and provides feedback to a user regarding the detection. However, in various implementations in which the electronic device detects objects using an imaging system, the field-of-view of the imaging system is substantially the same as the field-of-view of a user of the electronic device. Similarly, in various implementations in which the electronic device includes a display, the feedback to the user regarding the detection is provided via the display.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a perspective view of a head-mounted device in accordance with some implementations.

FIG. 2 is a block diagram of an example operating environment in accordance with some implementations.

FIG. 3 illustrates various field-of-views in accordance with some implementations.

FIGS. 4A-4H illustrate a device field-of-view of a physical environment during various time periods in accordance with some implementations.

FIG. 5 is a flowchart representation of a method of playing an audio notification in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for performing an action. In various implementations, the method is performed by a device including one or more image sensors, one or more speakers, one or more processors, and non-transitory memory. The method includes receiving, from the image sensor, an image of a physical environment having a device field-of-view different than a user field-of-view. The method includes detecting, in the image of the physical environment, an object at a location in the physical environment. The method includes determining that the location in the physical environment is outside an area of the user field-of-view. The method includes, in response to determining that the location in the physical environment is outside the area of the user field-of-view, playing, via the speaker, an audio notification of the detection.

In accordance with some implementations, a device includes one or more processors, a non-transitory memory, and one or more programs; the one or more programs are stored in the non-transitory memory and configured to be executed by the one or more processors. The one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

In various implementations, in response to detecting an object outside a user field-of-view, a device plays an audio notification of the detection. Thus, the field-of-awareness of the user is expanded by converting image data outside the user field-of-view into aural input that supplements a user's visual input.

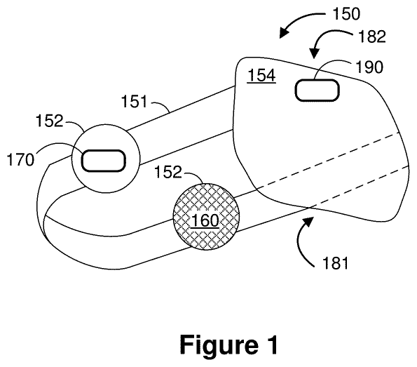

FIG. 1 illustrates a perspective view of a head-mounted device 150 in accordance with some implementations. The head-mounted device 150 includes a frame 151 including two earpieces 152 each configured to abut a respective outer ear of a user. The frame 151 further includes a front component 154 configured to reside in front of a field-of-view of the user. Each earpiece 152 includes an inward-facing speaker 160 (e.g., inward-facing, outward-facing, downward-facing, or the like) and an outward-facing imaging system 170. Further, the front component 154 includes a display 181 to display images to the user, an eye tracker 182 (which may include one or more rearward-facing image sensors configured to capture images of at least one eye of the user) to determine a gaze direction or point-of-regard of the user, and a scene tracker 190 (which may include one or more forward-facing image sensors configured to capture images of the physical environment) which may supplement the imaging systems 170 of the earpieces 152.

In various implementations, the head-mounted device 150 lacks the front component 154. Thus, in various implementations, the head-mounted device is embodied as a headphone device including a frame 151 with two earpieces 152 each configured to surround a respective outer ear of a user and a headband coupling the earpieces 152 and configured to rest on the top of the head of the user. In various implementations, each earpiece 152 includes an inward-facing speaker 160 and an outward-facing imaging system 170.

In various implementations, the headphone device lacks a headband. Thus, in various implementations, the head-mounted device 150 (or the earpieces 150 thereof) is embodied as one or more earbuds or earphones. For example, an earbud includes a frame configured for insertion into an outer ear. In particular, in various implementations, the frame is configured for insertion into the outer ear of a human, a person, and/or a user of the earbud. The earbud includes, coupled to the frame, a speaker 160 configured to output sound, and an imaging system 170 configured to capture one or more images of a physical environment in which the earbud is present. In various implementations, the imaging system 170 includes one or more cameras (or image sensors). The earbud further includes, coupled to the frame, one or more processors. The speaker 160 is configured to output sound based on audio data received from the one or more processors and the imaging system 170 is configured to provide image data to the one or more processors. In various implementations, the audio data provided to the speaker 160 is based on the image data obtained from the imaging system 170.

As noted above, in various implementations an earbud includes a frame configured for insertion into an outer ear. In particular, in various implementations, the frame is sized and/or shaped for insertion into the outer ear. The frame includes a surface that rests in the intertragic notch, preventing the earbud from falling downward vertically. Further, the frame includes a surface that abuts the tragus and the anti-tragus, holding the earbud in place horizontally. As inserted, the speaker 160 of the earbud is pointed toward the ear canal and the imaging system 170 of the earbud is pointed outward and exposed to the physical environment.

Whereas the head-mounted device 150 is an example device that may perform one or more of the methods described herein, it should be appreciated that other wearable devices having one or more speakers and one or more cameras can also be used to perform the methods. The wearable audio devices may be embodied in other wired or wireless form factors, such as head-mounted devices, in-ear devices, circumaural devices, supra-aural devices, open-back devices, closed-back devices, bone conduction devices, or other audio devices.

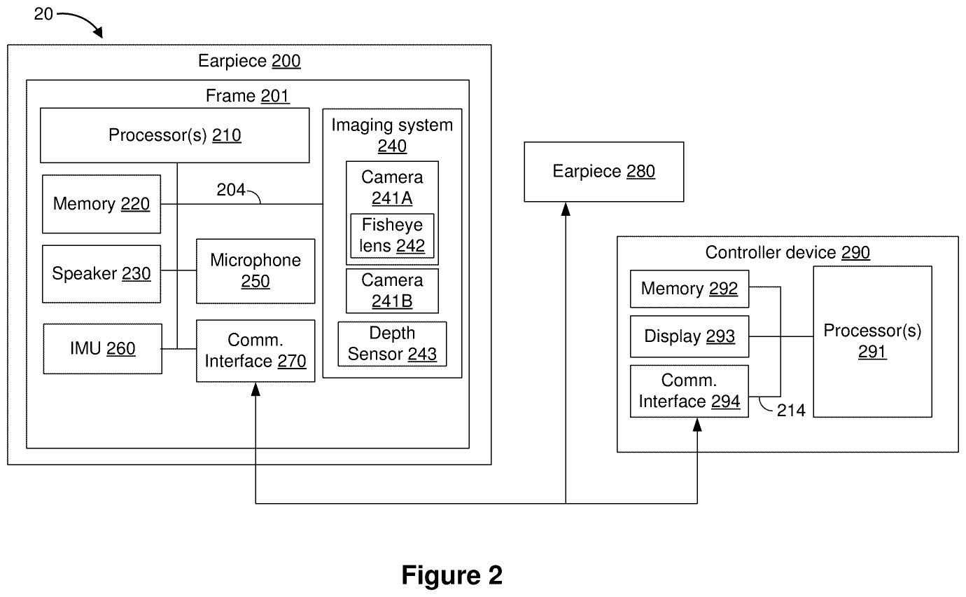

FIG. 2 is a block diagram of an operating environment 20 in accordance with some implementations. The operating environment 20 includes an earpiece 200. In various implementations, the earpiece 200 corresponds to the earpiece 152 of FIG. 1. The earpiece 200 includes a frame 201. In various implementations, the frame 201 is configured for insertion into an outer ear. The earpiece 200 includes, coupled to the frame 201 and, in various implementations, within the frame 201, one or more processors 210. The earpiece 200 includes, coupled to the frame 201 and, in various implementations, within the frame 201, memory 220 (e.g., non-transitory memory) coupled to the one or more processors 210.

The earpiece 200 includes a speaker 230 coupled to the frame 201 and configured to output sound based on audio data received from the one or more processors 210. The earpiece 200 includes an imaging system 240 coupled to the frame 201 and configured to capture images of a physical environment in which the earpiece 200 is present and provide image data representative of the images to the one or more processors 210. In various implementations, the imaging system 240 includes one or more cameras 241A, 241B. In various implementations, different cameras 241A, 241B have a different field-of-view. For example, in various implementations, the imaging system 240 includes a forward-facing camera and a rearward-facing camera. In various implementations, at least one of the cameras 241A includes a fisheye lens 242, e.g., to increase a size of the field-of-view of the camera 241A. In various implementations, the imaging system 240 includes a depth sensor 243. Thus, in various implementations, the image data includes, for each of a plurality of pixels representing a location in the physical environment, a color (or grayscale) value of the location representative of the amount and/or wavelength of light detected at the location and a depth value representative of a distance from the earpiece 200 to the location.

In various implementations, the earpiece 200 includes a microphone 250 coupled to the frame 201 and configured to generate ambient sound data indicative of sound in the physical environment. In various implementations, the earpiece 200 includes an inertial measurement unit (IMU) 260 coupled to the frame 201 and configured to determine movement and/or the orientation of the earpiece 200. In various implementations, the IMU 260 includes one or more accelerometers and/or one or more gyroscopes. In various implementations, the earpiece 200 includes a communications interface 270 coupled to frame configured to transmit and receive data from other devices. In various implementations, the communications interface 270 is a wireless communications interface.

The earpiece 200 includes, within the frame 201, one or more communication buses 204 for interconnecting the various components described above and/or additional components of the earpiece 200 which may be included.

In various implementations, the operating environment 20 includes a second earpiece 280 which may include any or all of the components of the earpiece 200. In various implementations, the frame 201 of the earpiece 200 is configured for insertion in one outer ear of a user and the frame of the second earpiece 200 is configured for insertion in another outer ear of the user, e.g., by being a mirror version of the frame 201.

In various implementations, the operating environment 20 includes a controller device 290. In various implementations, the controller device 290 is a smartphone, tablet, laptop, desktop, set-top box, smart television, digital media player, or smart watch. The controller device 290 includes one or more processors 291 coupled to memory 292, a display 293, and a communications interface 294 via one or more communication buses 214. In various implementations, the controller device 290 includes additional components such as any or all of the components described above with respect to the earpiece 200.

In various implementations, the display 293 is configured to display images based on display data provided by the one or more processors 291. In contrast, in various implementations, the earpiece 200 (and, similarly, the second earpiece 280) does not include a display or, at least, does not include a display within a field-of-view of the user when inserted into the outer ear of the user.

In various implementations, the one or more processors 210 of the earpiece 200 generates the audio data provided to the speaker 230 based on the image data received from the imaging system 240. In various implementations, the one or more processors 210 of the earpiece 200 transmits the image data via the communications interface 270 to the controller device 290, the one or more processors of the controller device 290 generates the audio data based on the image data, and the earpiece 200 receives the audio data via the communications interface 270. In either set of implementations, the audio data is based on the image data.

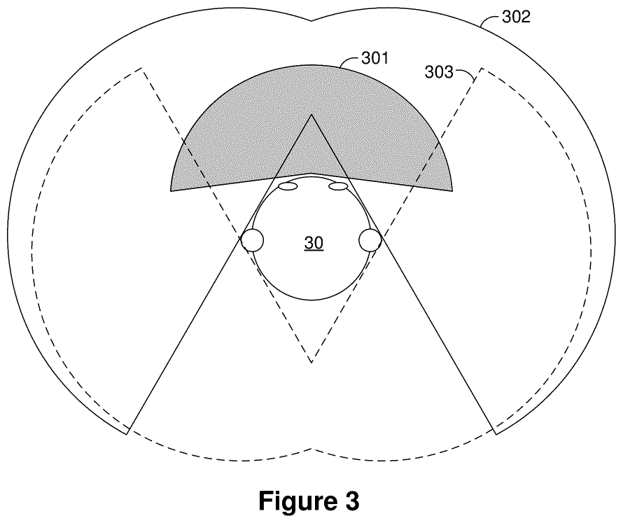

FIG. 3 illustrates various field-of-views in accordance with some implementations. A user field-of-view 301 of a user 30 typically extends approximately 300 degrees with varying degrees of visual perception within that range. For example, excluding far peripheral vision, the user field-of-view 301 is only approximately 120 degrees, and the user field-of-view 301 including only foveal vision (or central vision) is only approximately 5 degrees.

In contrast, a system (head-mounted device 150 of FIG. 1) may have a device field-of-view that includes views outside the user field-of-view 301 of the user 30. For example, a system may include a forward-and-outward-facing camera including a fisheye lens with a field-of-view of 180 degrees proximate to each ear of the user 30 and may have a device forward field-of-view 302 of approximately 300 degrees. Further, a system may further include a rearward-and-outward-facing camera including a fisheye lens with a field-of-view of 180 degrees proximate to each ear of the user 30 and may also have a device rearward field-of-view 303 of approximately 300 degrees. In various implementations, a system including multiple cameras proximate to each ear of the user can have a device field-of-view of a full 360 degrees (e.g., including the device forward field-of-view 302 and the device rearward field-of-view 303). It is to be appreciated that, in various implementations, the cameras (or combination of cameras) may have smaller or larger fields-of-view than the examples above.

The systems described above can perform a wide variety of functions. For example, in various implementations, while playing audio (e.g., music or an audiobook) via the speaker, in response to detecting a particular hand gesture (even a hand gesture performed outside a user field-of-view) in images captured by the imaging system, the system may alter playback of the audio (e.g., by pausing or changing the volume of the audio). For example, in various implementations, in response to detecting a hand gesture performed by a user proximate to the user's ear of closing an open hand into a clenched first, the system pauses the playback of audio via the speaker.

As another example, in various implementations, while playing audio via the speaker, in response to detecting a person attempting to engage the user in conversation or otherwise talk to the user (even if the person is outside the user field-of-view) in images captured by the imaging system, the system may alter playback of the audio. For example, in various implementations, in response to detecting a person behind the user attempting to talk to the user, the system reduces the volume of the audio being played via the speaker and ceases performing an active noise cancellation algorithm.

As another example, in various implementations, in response to detecting an object or event of interest in the physical environment in images captured by the imaging system, the system generates an audio notification. For example, in various implementations, in response to detecting a person in the user's periphery or outside the user field-of-view attempting to get the user's attention (e.g., by waving the person's arms), the device plays, via the speaker, an alert notification (e.g., a sound approximating a person saying “Hey!”). In various implementations, the system plays, via two or more speakers, the alert notification spatially such that the user perceives the alert notification as coming from the direction of the detected object.

As another example, in various implementations, in response to detecting an object or event of interest in the physical environment in images captured by the imaging system, the system stores, in the memory, an indication that the particular object was detected (which may be determined using images from the imaging system) in association with a location at which the object was detected (which may also be determined using images from the imaging system) and a time at which the object was detected. In response to a user query (e.g., a vocal query detected via the microphone), the system provides an audio response. For example, in response to detecting a water bottle in an office of the user, the system stores an indication that the water bottle was detected in the office and, in response to a user query at a later time of “Where is my water bottle?”, the device may generate audio approximating a person saying “In your office.”

As another example, in various implementations, in response to detecting an object in the physical environment approaching the user in images captured by the imaging system, the system generates an audio notification. For example, in various implementations, in response to detecting a car approaching the user at a speed exceeding a threshold, the system plays, via the speaker, an alert notification (e.g., a sound approximating the beep of a car horn). In various implementations, the system plays, via two or more speakers, the alert notification spatially such that the user perceives the alert notification as coming from the direction of the detected object.

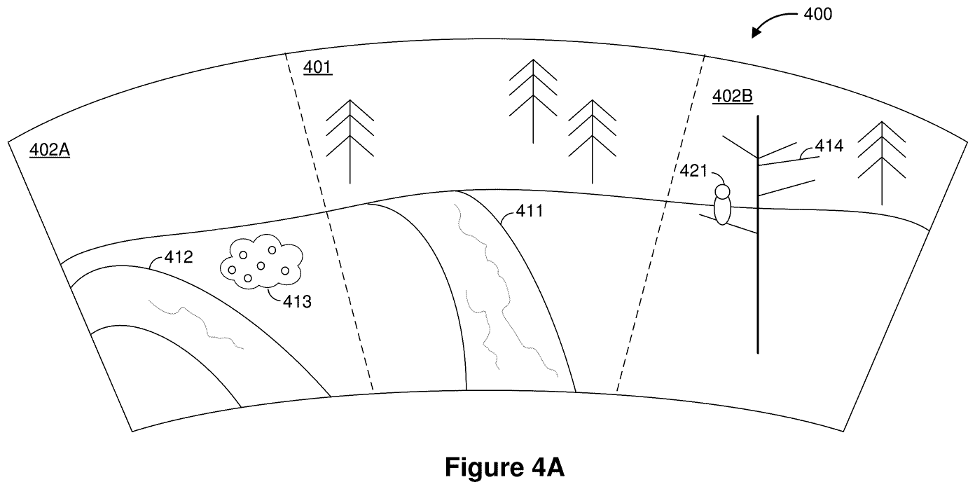

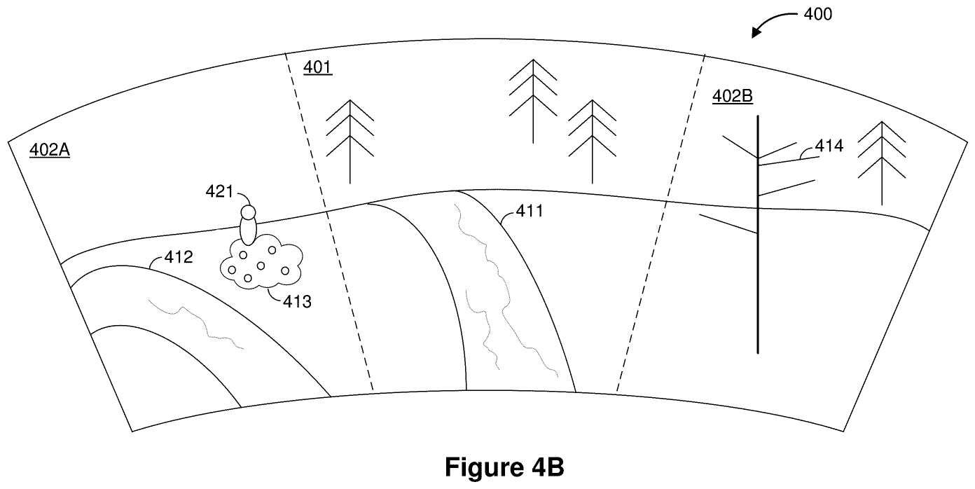

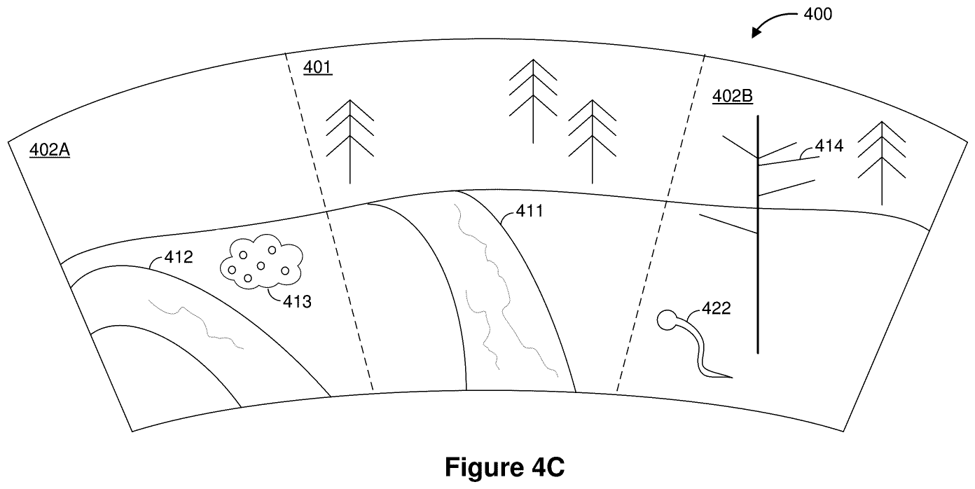

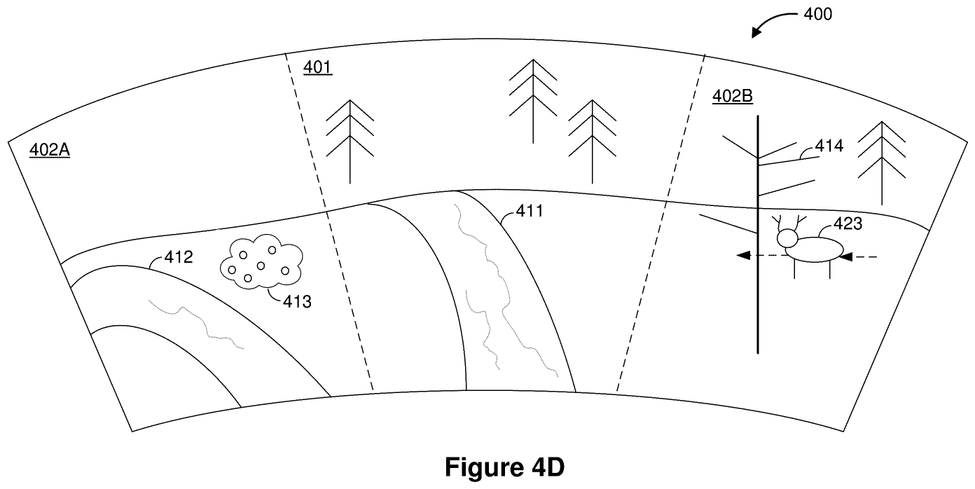

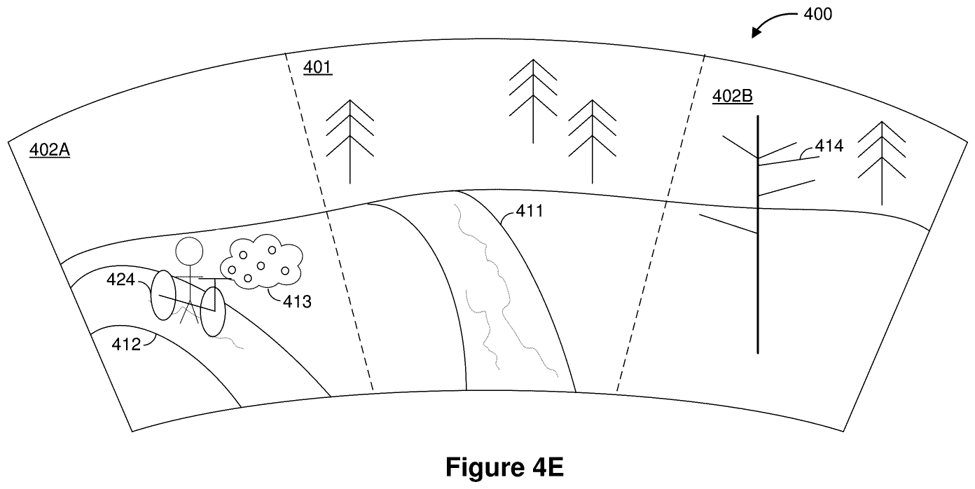

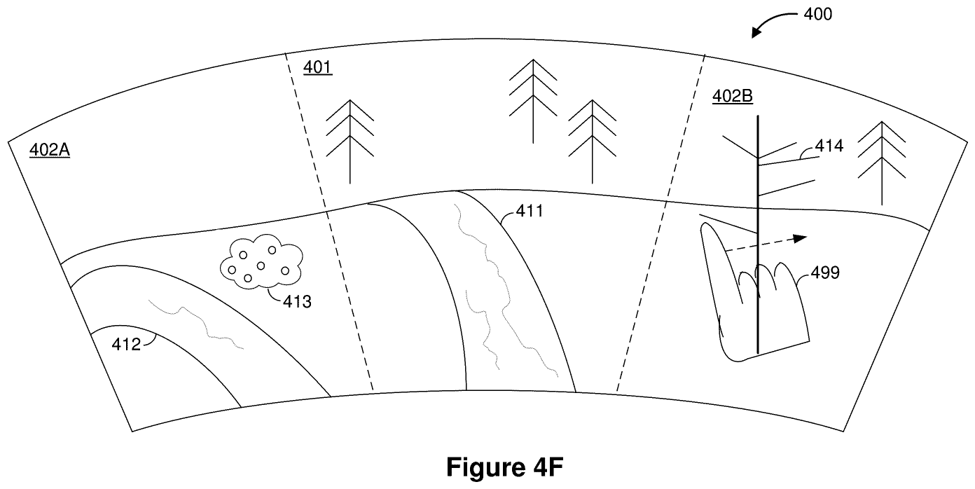

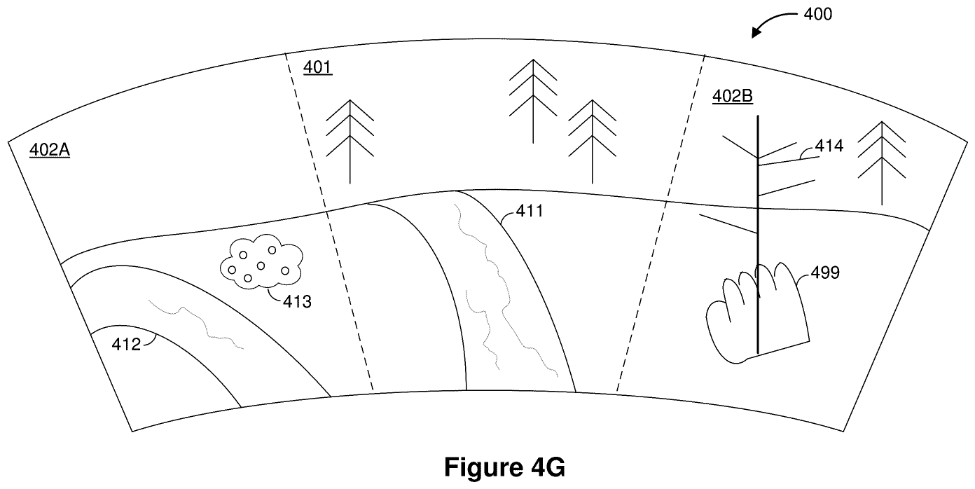

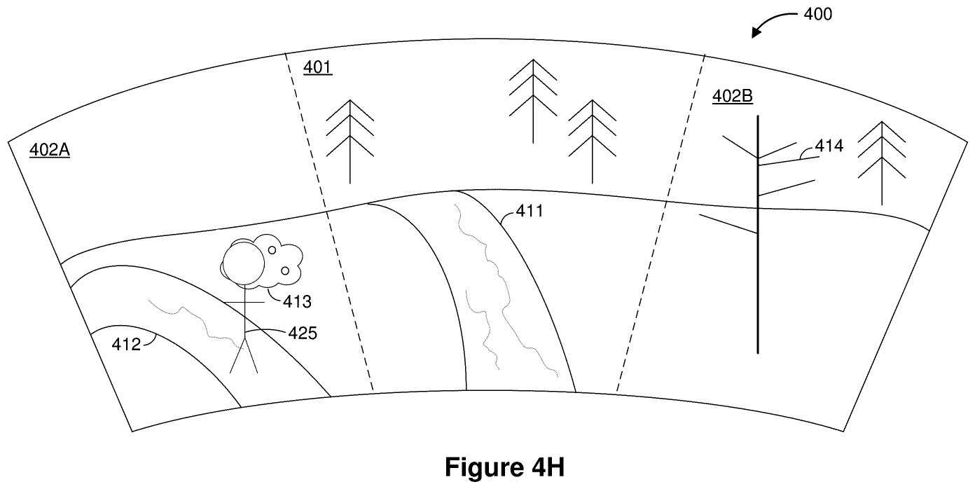

FIGS. 4A-4H illustrate a device field-of-view 400 of an outdoor physical environment during a series of time periods in various implementations. In various implementations, each time period is an instant, a fraction of a second, a few seconds, a few hours, a few days, or any length of time.

The device field-of-view 400 includes a user field-of-view 401 and both a left portion 402A outside of the user field-of-view 401 and a right portion 402B outside of the user field-of-view 401. In various implementations, the device field-of-view 400 does not include all of the user field-of-view 401. For example, in various implementations, the device field-of-view 400 includes a first portion of the user field-of-view 401 and does not include a second portion of the user field-of-view 401. In various implementations, the device field-of-view 400 does not include any of the user field-of-view 401.

The device field-of-view 400 includes a primary trail 411 upon which the user is walking in the user field-of-view 401 and a secondary trail 412 in the left portion 402A. The device field-of-view 400 includes a bush 413 in the left portion 402A and a tree 414 in the right portion 402B.

FIG. 4A illustrates the device field-of-view 400 during a first time period. During the first time period, the device field-of-view 400 includes a bird 421 perched in the tree 414 in the right portion 402B. In various implementations, the device detects the bird 421 as an object having a particular object type, e.g., using computer-vision techniques such as a model trained to detect and classify various objects. In various implementations, the device detects the bird 421 as an object type of “ANIMAL”, an object type of “BIRD”, and/or an object type of “ROBIN”.

In response to detecting the bird 421, the device generates an audio notification of the detection. In various implementations, the audio notification emulates the sound of a person saying an object type of the object. In various implementations, the audio notification emulates the sound of the object, e.g., a bird call. In various implementations, the audio notification includes other types of sounds.

In various implementations, the audio notification is spatialized so as to be perceived as being produced from the location of the detected object. Accordingly, in various implementations, the audio notification is played differently in the two ears of the user. In various implementations, the audio notification is spatialized using stereo panning. For example, during the first time period, when the bird 421 is in the right portion 402B, the audio notification is played louder in a first speaker proximate to the right ear of the user than in a second speaker proximate to a left ear of the user. As another example, in various implementations, the volume of the audio notification is based on a distance to the detected object. For example, in various implementations, the audio notification is louder or at a higher or lower pitch when the detected object is closer to the device. In various implementations, the audio notification is spatialized using binaural rendering in which a source signal is filtered with two head-related transfer functions (HRTFs) that are based on the relative position of the head of the user and the detected object (e.g., determined using head tracking) and the resultant signals are played the two ears of the user. For example, during the first time period, when the bird 421 is in the right portion 402B, the audio notification is filtered with a first right-ear transfer function to generate a right-ear signal and filtered with a first left-ear transfer function to generate a left-ear signal. The right-ear signal is played in the first speaker proximate to the right ear of the user and the left-ear signal is played in the second speaker proximate to a left ear of the user.

FIG. 4B illustrates the device field-of-view 400 during a second time period subsequent to the first time period. During the second time period, the bird 421 has moved from the tree 414 in the right portion 402B to the bush 413 in the left portion 402A. In response to detecting the bird 421 as an object having a particular object type, the device generates an audio notification of the detection. In various implementations, the audio notification is spatialized so as to be perceived as being produced from the location of the detected object. For example, during the second time period, when the bird 421 is in the left portion 401A, the audio notification is played louder in the second speaker proximate to the left ear of the user than in the first speaker proximate to a right ear of the user. As another example, during the second time period, when the bird 421 is in the left portion 402B, the audio notification is filtered with a second right-ear transfer function (different than the first right-ear transfer function due to the different relative position of the bird 421 to the head of the user) to generate a right-ear signal and filtered with a second left-ear transfer function to generate a left-ear signal. The right-ear signal is played in the first speaker proximate to the right ear of the user and the left-ear signal is played in the second speaker proximate to a left ear of the user.

In various implementations, a spatialized audio notification is produced periodically, at least during the first time period and second time period, to allow a user to track a detected object aurally, even outside of the user field-of-view 401.

FIG. 4C illustrates the device field-of-view 400 during a third time period subsequent to the second time period. During the third time period, the bird 421 has left the device field-of-view 400 and the device field-of-view 400 includes a snake 422 on the ground in the right portion 402B. In various implementations, the device detects the snake 422 as an object having a particular object type, e.g., using computer-vision techniques such as a model trained to detect and classify various objects. In various implementations, the device detects the snake 422 as an object type of “ANIMAL”, an object type of “SNAKE”, and/or an object type of “RATTLESNAKE”.

In response to detecting the snake 422 as an object having a particular object type, the device generates an audio notification of the detection. In various implementations, the audio notification emulates the sound of a person saying an object type of the object. In various implementations, the audio notification emulates the sound of the object, e.g., a rattlesnake rattle. In various implementations, the audio notification includes other types of sounds.

In various implementations, the audio notification is spatialized so as to be perceived as being produced from the location of the detected object. In various implementations, the volume of the audio notification is based on a distance to the detected object. For example, in various implementations, the audio notification is louder when the detected object is closer to the device. In various implementations, just as a real rattlesnake rattle, a frequency of the audio notification is based on a distance to the detected object. For example, in various implementations, the frequency of the audio notification is higher when the detected object is closer to the device.

In various implementations, the audio notification is different for different types of objects. For example, in various implementations, in response to detecting the bird 421 in FIG. 4A, the audio notification is a bird call and, in response to detecting the snake 422 in FIG. 4C, the audio notification is a rattlesnake rattle.

FIG. 4D illustrates the device field-of-view 400 during a fourth time period subsequent to the third time period. During the fourth time period, the snake 422 has left the device field-of-view 400 and the device field-of-view 400 includes a deer 423 moving behind the tree 414 in the right portion 402B.

In various implementations, the device detects the deer 423 as an object having a particular object type, e.g., using computer-vision techniques such as a model trained to detect and classify various objects. In various implementations, the device detects the deer 423 as an object type of “ANIMAL”, an object type of “DEER”, and/or an object type of “MULE DEER”. However, in various implementations, the device detects the deer 423 as a moving object rather than or in addition to detecting the deer 423 as an object having a particular object type.

In response to detecting the deer 423 as a moving object, the device generates an audio notification of the detection. In various implementations, the audio notification emulates the sound of a person indicating the detection of motion, e.g., “MOTION”. In various implementations, the audio notification emulates the sound of the object moving in the physical environment, e.g., the rustling of leaves or breaking of branches, which may be based on an object type of the moving object. In various implementations, the audio notification includes other types of sounds.

In various implementations, the audio notification is spatialized so as to be perceived as being produced from the location of the detected moving object. In various implementations, the audio notification is based on a speed of the motion of the detected moving object. For example, in various implementations, a frequency of the audio notification is higher when the object is moving faster. In various implementations, the audio notification is based on a size of the detected moving object. For example, in various implementations, a volume of the audio notification is louder when the object is larger.

FIG. 4E illustrates the device field-of-view 400 during a fifth time period subsequent to the fourth time period. During the fifth time period, the deer 423 has left the device field-of-view 400 and the device field-of-view 400 includes a bicycle 424 moving towards the device on the secondary trail 412 in the left portion 402A.

In various implementations, the device detects the bicycle 424 as an object having a particular object type, e.g., using computer-vision techniques such as a model trained to detect and classify various objects. In various implementations, the device detects the bicycle 424 as an object type of “VEHICLE” and/or an object type of “BICYCLE”. However, in various implementations, the device detects the bicycle 424 as a moving object rather than or in addition to detecting the bicycle 424 as an object having a particular object. Further, in various implementations, the device detects the bicycle 424 as a moving object that is moving towards the electronic device, otherwise referred to as an incoming object.

In response to detecting the bicycle as an incoming object, the device generates an audio notification of the detection. In various implementations, the audio notification emulates the sound of a person indicating the detection of an incoming object, e.g., “INCOMING” or “LOOK OUT”. In various implementations, the audio notification emulates the sound of the object moving in the physical environment, e.g., a bicycle bell, which may be based on an object type of the incoming object.

In various implementations, the audio notification is spatialized so as to be perceived as being produced from the location of the detected incoming object. In various implementations, the audio notification is based on a likelihood of the incoming object impacting the device, e.g., based on the trajectory and/or speed of the incoming object.

As described above, in various implementations, in response to detecting an object within a device field-of-view 400, but outside a user field-of-view 401 or outside a portion of the user field-of-view 401 (e.g., outside a foveal region, outside a peripheral region, or the like), the device generates an audio notification. In various implementations, in response to detecting an object within a device field-of-view 400, but outside a user field-of-view 401 or outside a portion of the user field-of-view 401 (e.g., outside a foveal region, outside a peripheral region, or the like), the device alters playback of audio, for example, by changing an audio track, pausing or resuming playback, and/or ceasing to perform an active noise cancellation.

FIG. 4F illustrates the device field-of-view 400 during a sixth time period subsequent to the fifth time period. During the sixth time period, the bicycle 424 has left the device field-of-view 400 and the device field-of-view 400 includes a right hand 499 of a user performing a first hand gesture in the right portion 402B. To better illustrate interaction of the right hand 499 with the physical environment, the right hand 499 is illustrated as transparent. In various implementations, the first hand gesture is a skip hand gesture in which the index finger is extended and, in various implementations, the other digits of the hand are contracted while the index finger is moved away from the ear of the user (and the device).

During the sixth time period, prior to detecting the right hand 499 performing the first hand gesture, the device plays a first audio track. In response to detecting the right hand 499 performing the first hand gesture, the device plays a second audio track.

FIG. 4G illustrates the device field-of-view 400 during a seventh time period subsequent to the sixth time period. During the seventh time period, the device field-of-view 400 includes the right hand 499 of a user performing a second hand gesture in the right portion 402B. In various implementations, the second hand gesture is a pause hand gesture in which the fingers are contracted to form a fist.

During the seventh time period, prior to detecting the right hand 499 performing the second hand gesture, the device plays the second audio track. In response to detecting the right hand 499 performing the second hand gesture, the device pauses playback of the second audio track.

While specific gestures and associated functions are described above, it should be appreciated that other gestures associated with other functions of the device may be detected within the device field-of-view 400.

FIG. 4H illustrates the device field-of-view 400 during an eighth time period subsequent to the seventh time period. During the eighth time period, the device field-of-view 400 includes a person 425 attempting to communicate with the user in the left portion 402A.

In various implementations, the device may detect the person 425 attempting to communicate with the user based on an object recognition algorithm that identifies a person who is positioned within the device field-of-view 400 and is performing physical gestures that are indicative of a person speaking towards the user (e.g., the person's mouth moving, the person's eyes being directed towards the user, etc.).

During the eighth time period, prior to detecting the person 425 attempting to communicate with the user, the device performs active noise cancellation. In response to detecting the person 425 attempting to communicate with the user, the device ceases performing active noise cancellation.

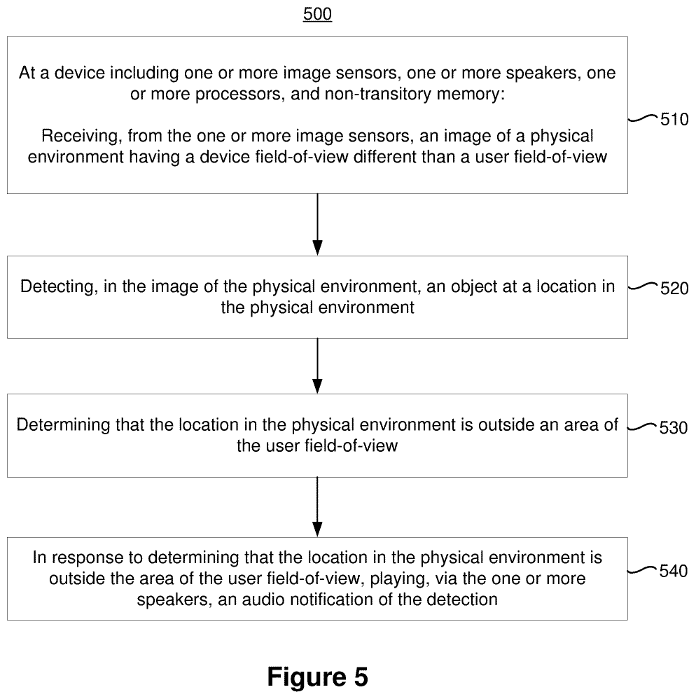

FIG. 5 is a flowchart representation of a method 500 of playing an audio notification in accordance with some implementations. In various implementations, the method 500 is performed by a device including one or more image sensors, one or more speakers, one or more processors, and non-transitory memory (e.g., the head-mounted device 150 of FIG. 1 or the earpiece 200 of FIG. 2). In various implementations, the method 500 is performed by a device without a display. In various implementations, the method 500 is performed by a device with a display. In various implementations, the method 500 is performed using an audio device (e.g., the head-mounted device 150 of FIG. 1 or the earpiece 200 of FIG. 2) in conjunction with a peripheral device (e.g., the controller device 290 of FIG. 2). In various implementations, the method 500 is performed by processing logic, including hardware, firmware, software, or a combination thereof. In various implementations, the method 500 is performed by a processor executing instructions (e.g., code) stored in a non-transitory computer-readable medium (e.g., a memory).

The method 500 begins, in block 510, with the device receiving, from the one or more image sensors, an image of a physical environment having a device field-of-view different than a user field-of-view. For example, in FIGS. 4A-4H, the image of the physical environment has a device field-of-view 400 that includes the user field-of-view 401 and both a left portion 402A outside of the user field-of-view 401 and a right portion 402B outside of the user field-of-view 401. In various implementations, the device field-of-view includes one or more areas outside the user field-of-view and may include none or only a portion of the user field-of-view.

The method 500 continues, in block 520, with the device detecting, in the image of the physical environment, an object at a particular location in the physical environment. For example, in FIG. 4A, the device detects the bird 421 in the right portion 402B outside the user field-of-view 401.

In various implementations, the device transmits the image of the physical environment to a peripheral device which detects the object in the image of the physical environment. In response to the detection, the peripheral device transmits an indication of the detection to the device. Accordingly, in various implementations, detecting the object at the particular location in the physical environment includes transmitting, to a peripheral device, the image of the physical environment to a peripheral device and receiving, from the peripheral device, an indication of the detection.

For example, in various implementations, the indication is an audio signal, e.g., a spatialized audio signal, to be played by the device. As another example, in various implementations, the indication includes parameters indicative of the detection, such as the location in the environment of the object, the object type of the object, and/or motion parameters of the object including speed and/or trajectory. In response to receiving the parameters indicative of the detection, the device generates the audio signal to be played by the device.

The method 500 continues, in block 530, with the device determining that the location in the physical environment is outside an area of the user field-of-view. For example, in various implementations, the device determines that the location in the physical environment is completely outside the user field-of-view. Thus, in various implementations, determining that the location in the physical environment is outside the area of the user field-of-view includes determining that the location in the physical environment is outside the user field-of-view. As another example, in various implementations, the device determines that the location is within the user field-of-view, but outside a portion of the user field-of-view such as a foveal portion of the user field-of-view or a peripheral portion of the user field-of-view. Thus, in various implementations, determining that the location in the physical environment is outside the area of the user field-of-view includes determining that the location in the physical environment is outside a portion of the user field-of-view.

In various implementations, to determine that the location in the physical environment is outside the area of the user field-of-view, the device estimates the area of the user field-of-view and determines that the location is outside the estimated area, e.g., not within the estimated area. Thus, in various implementations, determining that the location in the physical environment is outside the area of the user field-of-view includes estimating the area of the user field-of-view.

In various implementations, the device includes an eye tracker. For example, the head-mounted device 150 of FIG. 1 includes the eye tracker 182. In various implementations, based on the information from the eye tracker, the device estimates the area of the user field-of-view as an area surrounding the location at which the user is looking. For example, a foveal portion of the user field-of-view may an area be approximately 5 degrees (or some other value) surrounding the location at which the user is looking. As another example, a near-peripheral portion of the user field-of-view may be approximately 30 degrees (or some other value) surrounding the location at which the user is looking. Thus, in various implementations, estimating the area of the user field-of-view includes determining an area around a gaze location of the user.

In various implementations, the device includes multiple image sensors. For example, the head-mounted device 150 of FIG. 1 includes two outward-facing imaging systems 170. As another example, the earpiece 200 in conjunction with the earpiece 280 of FIG. 2 includes two imaging systems 240. In various implementations, the image of the physical environment is generated by combining two images of the physical environment from two image sensors, each of the two images having two different field-of-views. In various implementations, the device estimates the area of the user field-of-view as an area surrounding a location (e.g., the center) in an area where the different field-of-views overlap. For example, a near-peripheral portion of the user field-of-view may be approximately 30 degrees (or some other value) surrounding the center of the area where the different field-of-views overlap. Thus, in various implementations, estimating the area of the user field-of-view includes determining an area around a location in an overlap region of the image of the physical environment.

In various implementations, the device determines the area of the user field-of-view based on user feedback. For example, during a calibration procedure, a user may define the area of the user field-of-view by placing a finger at the edge of the area of the user field-of-view. In response to detecting the finger of the user, the device determines the area of the user field-of-view as being to the left or right of the finger. As another example, a user may define the user field-of-view by placing a finger at the edge of the user field-of-view. In response to detecting the finger of the user, the device determines a mid-peripheral portion of user field-of-view as being half (or some other fraction) of the image of the physical environment to the left or right of the finger. Thus, in various implementations, estimating the area of the user field-of-view includes receiving user feedback regarding the user field-of-view.

The method 500 continues, in block 540, with the device, in response to determining that the location is outside the area of the user field-of-view playing, via the one or more speakers, an audio notification of the detection. For example, in FIG. 4A, in response to detecting the bird 421 in the right portion 402B outside the user field-of-view 401, the device plays an audio notification of the word “BIRD” or a bird call.

In various implementations, the method 500 includes, in response to determining that the location is within the area of the user field-of-view forgoing playing the audio notification. By playing the audio notification only in response to determining that the location is outside the area of the user field-of-view, the user field-of-awareness is expanded without distracting the user by playing audio notifications in response to detecting objects the user can already detect (e.g., see). Further, the device saves power by playing an audio notification only when the object is detected outside of the area of the user field-of-view. In various implementations, because the device does not play an audio notification for objects detected within the area of the user field-of-view, the device does not scan for objects within the area of the user field-of-view. Thus, in various implementations, detecting an object at a location in the physical environment (in block 520) includes scanning (or transmitting to a peripheral device) the portion of the image of the physical environment outside the area of the user field-of-view without scanning (or transmitting to a peripheral device) the portion of the image of the physical environment within the area of the user field-of-view. Thus, the device realizes additional power and/or bandwidth savings.

In various implementations, playing the audio notification includes playing the audio notification spatially from the location. Accordingly, in various implementations, playing the audio notification spatially includes playing the audio notification differently in the two ears of the user. In various implementations, the audio notification is spatialized using stereo panning. For example, in FIG. 4A, in response to detecting the bird 421 in the right portion 402B outside the user field-of-view 401, the device plays the audio notification louder in a first speaker proximate to the right ear of the user than in a second speaker proximate to the left ear of the user. As another example, in various implementations, the volume of the audio notification is based on a distance to the detected object. For example, in various implementations, the audio notification is louder when the detected object is closer to the device. In various implementations, the audio notification is spatialized using binaural rendering in which a source signal is filtered with two head-related transfer functions (HRTFs) that are based on the relative position of the head of the user and the detected object (e.g., determined using head tracking) and the resultant signals are played in the two ears of the user. For example, in FIG. 4A, in response to detecting the bird 421 in the right portion 402B outside the user field-of-view 401, the audio notification is filtered with a first right-ear transfer function to generate a right-ear signal and filtered with a first left-ear transfer function to generate a left-ear signal. The right-ear signal is played in the first speaker proximate to the right ear of the user and the left-ear signal is played in the second speaker proximate to a left ear of the user.

In various implementations, the method 500 includes tracking an object in multiple images of the physical environment. For example, in various implementations, the method 500 includes receiving, from the image sensor, a second image of the physical environment having a device field-of-view different than the user field-of-view. The method 500 includes detecting, in the second image of the physical environment, the object at a second location in the physical environment. The method 500 includes playing, via the speaker, a second audio notification of the detection spatially from the second location. For example, in FIG. 4A, in response to detecting the bird 421 in the right portion 402B, the device plays a first audio notification of a bird call and, in FIG. 4B, in response to detecting the bird 421 in the left portion 402A, the device plays a second audio notification of a bird call.

In various implementations, the second location is also outside the area of the user field-of-view. Although, in various implementations, the device forgoes playing the audio notification if the location is within the area of the user field-of-view, in various implementations, during tracking, the device plays the second audio notification even if the second location is within the area of the user field-of-view. Thus, in various implementations, the second location is within the area of the user field-of-view. However, in various implementations, when the object is detected in the second location within the area of the user field-of-view, the device does not play an audio notification. Thus, in various implementations, the method 500 includes receiving, from the image sensor, a second image of the physical environment having a device field-of-view different than the user field-of-view. The method 500 includes detecting, in the second image of the physical environment, the object at a second location in the physical environment within the area of the user field-of-view. The method 500 includes forgoing playing, via the one or more speakers, a second audio notification of the detection.

In various implementations, the method 500 includes detecting multiple objects in the image of the environment and playing multiple corresponding audio notifications. For example, in various implementations, the method 500 includes detecting, in the image of the physical environment, a second object at a second location in the physical environment and playing, via the speaker, a second audio notification of the detection spatially from the second location.

In various implementations, detecting the object at the location (in block 520) includes determining an object type of the object and playing the audio notification (in block 530) is based on the object type. For example, in FIG. 4A, in response to detecting the bird 421, the device plays an audio notification of a bird call and, in FIG. 4C, in response to detecting the snake 422, the device plays an audio notification of a rattlesnake rattle. Thus, in various implementations, the audio notification and the second audio notification are different, e.g., based on the object types of the object and the second object.

In various implementations, detecting the object at the location (in block 520) includes determining a motion of the object and playing the audio notification (in block 530) is based on the motion of the object. For example, in various implementations, the audio notification indicates that a moving object has been detected. For example, in FIG. 4D, the device detects the deer 423 as a moving object and plays an audio notification based on detecting a moving object, e.g., rustling leaves and breaking branches.

In various implementations, determining the motion of the object includes determining a speed of the object. For example, in various implementations, the audio notification is based on a speed of the object, wherein faster objects generate a louder audio notification.

In various implementations, determining the motion of the object includes determining an incoming motion of the object towards the device. For example, in FIG. 4E, the device detects the bicycle 424 as an incoming object and plays an audio notification based on detecting an incoming object, e.g., a bicycle bell.

In various implementations, playing the audio notification includes generating an audio signal indicative of the detection and playing, via the speaker, the audio signal. For example, in FIG. 4C, in response to detecting the snake 422, the device generates an audio signal of a rattlesnake rattle and plays the audio signal via the speaker. Thus, in various implementations, playing the audio notification includes playing a new sound that would not have otherwise been played had the object not been detected. In various implementations, playing the audio notification includes playing sound when, had the object not been detected, no sound would be played.

In various implementations, playing the audio notification includes altering playback, via the speaker, of an audio stream. For example, in FIG. 4F, in response to detecting the right hand 499 performing the first hand gesture, the device changes playback from a first audio track to a second audio track. As another example, in FIG. 4G, in response to detecting the right hand 499 performing the second hand gesture, the device changes playback from a second audio track to pausing the second audio track. As another example, in FIG. 4H, in response to detecting the person 425 attempting to communicate with the user, the device ceases performing active noise cancellation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device including one or more image sensors, one or more speakers, one or more processors, and non-transitory memory:
receiving, from the one or more image sensors, an image of a physical environment having a device field-of-view different than a user field-of-view;
detecting, in the image of the physical environment, an object at a location in the physical environment;
determining that the location in the physical environment is outside an area of the user field-of-view; and
in response to determining that the location in the physical environment is outside the area of the user field-of-view, playing, via the one or more speakers, an audio notification of the detection.

2. The method of claim 1, further comprising, in response to determining that the location is within the area of the user field-of-view, forgoing playing the audio notification.

3. The method of claim 1, wherein detecting the object at the location in the physical environment includes transmitting, to a peripheral device, the image of the physical environment, and receiving, from the peripheral device, an indication of the detection.

4. The method of claim 1, wherein determining that the location in the physical environment is outside the area of the user field-of-view includes determining that the location in the physical environment is outside the user field-of-view.

5. The method of claim 1, wherein determining that the location in the physical environment is outside the area of the user field-of-view includes determining that the location in the physical environment is outside a portion of the user field-of-view.

6. The method of claim 1, wherein determining that the location in the physical environment is outside the area of the user field-of-view includes estimating the area of the user field-of-view.

7. The method of claim 6, wherein estimating the area of the user field-of-view includes determining an area around a gaze location of the user.

8. The method of claim 1, wherein playing the audio notification includes playing the audio notification spatially from the location.

9. The method of claim 8, further comprising:
receiving, from the one or more image sensors, a second image of the physical environment having a device field-of-view different than the user field-of-view;
detecting, in the second image of the physical environment, the object at a second location in the physical environment; and
playing, via the one or more speakers, a second audio notification of the detection spatially from the second location.

10. The method of claim 8, further comprising:
receiving, from the one or more image sensors, a second image of the physical environment having a device field-of-view different than the user field-of-view;
detecting, in the second image of the physical environment, the object at a second location in the physical environment within the area of the user field-of-view; and
forgoing playing, via the one or more speakers, a second audio notification of the detection.

11. The method of claim 1, further comprising:
detecting, in the image of the physical environment, a second object at a second location in the physical environment; and
playing, via the one or more speakers, a second audio notification of the detection of the second object spatially from the second location.

12. The method of claim 1, wherein detecting the object at the location includes determining an object type of the object and wherein playing the audio notification is based on the object type.

13. The method of claim 1, wherein detecting the object at the location includes determining a motion of the object and wherein playing the audio notification is based on the motion of the object.

14. The method of claim 1, wherein playing the audio notification includes generating an audio signal indicative of the detection and playing, via the one or more speakers, the audio signal.

15. The method of claim 1, wherein playing the audio notification includes altering playback, via the one or more speakers, of an audio stream.

16. A device comprising:
one or more image sensors;
one or more speakers;
a non-transitory memory; and
one or more processors to:
receive, from the one or more image sensors, an image of a physical environment having a device field-of-view different than a user field-of-view;
detect, in the image of the physical environment, an object at a location in the physical environment;
determine that the location in the physical environment is outside an area of the user field-of-view; and
in response to determining that the location in the physical environment is outside the area of the user field-of-view, play, via the one or more speakers, an audio notification of the detection.

17. The device of claim 16, wherein the one or more processors are further to, in response to determining that the location is within the area of the user field-of-view, forgo playing the audio notification.

18. The device of claim 16, wherein the one or more processors are to determine an object type of the object and play the audio notification based on the object type.

19. The device of claim 16, wherein the one or more processors are to determine a motion of the object and play the audio notification based on the motion of the object.

20. A non-transitory memory storing one or more programs, which, when executed by one or more processors of a device including one or more image sensors and one or more speakers cause the device to:
receive, from the one or more image sensors, an image of a physical environment having a device field-of-view different than a user field-of-view;
detect, in the image of the physical environment, an object at a location in the physical environment;
determine that the location in the physical environment is outside an area of the user field-of-view; and
in response to determining that the location in the physical environment is outside the area of the user field-of-view, play, via the one or more speakers, an audio notification of the detection.
